(19) United States
(12) Patent Application Publication
(10) Pub. No.: US 2015/0235394 A1
(43) Pub. Date: Aug. 20, 2015

(54) Method And Apparatus For Displaying One Or More Waveforms

(71) Applicant: McKesson Financial Holdings, Hamilton (BM)

(72) Inventor: Elan Ben-Oni, El Cerrito, CA (US)

(73) Assignee: McKesson Financial Holdings, Hamilton (BM)

(21) Appl. No.: 14/183,998

(22) Filed: Feb. 19, 2014

(51) Int. Cl. G06T 11/20

(52) U.S. Cl. CPC G06T 11/206

(57) ABSTRACT

A method, apparatus and computer program product are therefore provided in order to provide for display of waveforms. An example method may include concurrently displaying a first waveform display area and a second waveform display area, wherein the first waveform display area displays a first waveform. The first waveform display area may include a first plurality of display areas corresponding to sensor readings associated with the first waveform. The second waveform display area may display a second waveform. The second waveform display area may include a second plurality of display areas corresponding to sensor readings associated with the second waveform. The method may also include receiving a first input via a waveform selection control displayed in a waveform selection area, the first input defining at least a portion of the first waveform, and adjusting the display of the first waveform within the first waveform display area as defined by the first input.

### TECHNOLOGICAL FIELD

An example embodiment of the present invention relates generally to electrocardiogram displays, and, more particularly, to a method and apparatus for formatting display of one or more electrocardiogram waveforms.

### BACKGROUND

Recent trends in technology have provided for increased interoperability between devices. As computing devices have become more powerful, it is increasingly common for mobile devices to be used in roles that were formerly the domain of desktop and mainframe computers. Users are frequently able to employ smart phones and tablet computers to perform tasks that previously would have required bulky displays and hardware enclosures. One technological field in particular that has benefited from these advancements is that of medical diagnostics.

Medical diagnostic devices have traditionally required special purpose hardware and software to analyze diagnostic sensor input. Display and analysis equipment might, at best, be attached to a cart structure that provided portability throughout different parts of a medical facility. However, the proliferation of mobile devices such as tablets computers, netbooks, and smart phones has provided practitioners with lightweight, portable devices that also possess detailed displays and significant processing power. Some manufacturers have leveraged these mobile devices via display and analysis applications to eliminate the need for specialized display and analysis hardware for analyzing medical diagnostic data.

However, the use of these mobile devices also presents new challenges compared to the specially designed display and analysis equipment of the past. Mobile devices may have a constrained display area, making fine measurements and calibrations of data difficult. Limited display areas may seem cluttered and input operations may be difficult due to the small screen size of some touch screen displays. These problems are particularly pronounced in scenarios where a practitioner is comparing two or more sets of data. For example, analysis of electrocardiogram (ECG) waveforms typically involves comparison of a previously captured waveform with a newly captured waveform in order to note any differences between the old waveform and the new waveform. Simultaneous display of both waveforms may require condensing of the display interface, making it difficult to analyze both waveforms at once. Through applied effort, ingenuity, and innovation, Applicant has solved many of these identified problems by developing a solution that is embodied by the present invention, which is described in detail below.

### BRIEF SUMMARY

A method, apparatus and computer program product are therefore provided according to an example embodiment of the present invention in order to provide for improved displaying of waveforms.

Embodiments may include methods, apparatuses, and computer readable storage media for displaying one or more waveforms. An example embodiment of a method may include concurrently displaying a first waveform display area and a second waveform display area, wherein the first waveform display area displays a first waveform. The first waveform display area may include a first plurality of display areas corresponding to sensor readings associated with the first waveform. The second waveform display area may display a second waveform. The second waveform display area may include a second plurality of display areas corresponding to sensor readings associated with the second waveform. The method may further include receiving a first input via a waveform selection control displayed in a waveform selection area. The first input may define at least a portion of the first waveform. The method may also include adjusting the display of the first waveform within the first waveform display area to display the portion of the first waveform defined by the first input.

An embodiment of an apparatus may include processing circuitry configured to cause the apparatus to perform certain actions. The actions may include concurrently displaying a first waveform display area and a second waveform display area, wherein the first waveform display area displays a first waveform. The first waveform display area may include a first plurality of display areas corresponding to sensor readings associated with the first waveform. The second waveform display area may display a second waveform. The second waveform display area may include a second plurality of display areas corresponding to sensor readings associated with the second waveform. The apparatus may further receive a first input via a waveform selection control displayed in a waveform selection area. The first input may define at least a portion of the first waveform. The apparatus may also adjust the display of the first waveform within the first waveform display area to display the portion of the first waveform defined by the first input.

Embodiments may further include a computer program product including at least one non-transitory computer-readable storage medium. The computer-readable storage medium may include program instructions for use with a computer which include program instructions configured to concurrently display a first waveform display area and a second waveform display area, wherein the first waveform display area displays a first waveform. The first waveform display area may include a first plurality of display areas corresponding to sensor readings associated with the first waveform. The second waveform display area may display a second waveform. The second waveform display area may include a second plurality of display areas corresponding to sensor readings associated with the second waveform. The instructions may further include receiving a first input via a waveform selection control displayed in a waveform selection area. The first input may define at least a portion of the first waveform. The instructions may also include adjusting the display of the first waveform within the first waveform display area to display the portion of the first waveform defined by the first input.

Alternative example embodiments may provide another method for displaying one or more waveforms. This method may include concurrently displaying a first waveform and a second waveform within a waveform display area. The waveform display area may include a plurality of display areas corresponding to sensor readings. The sensor readings associated with each waveform may be concurrently displayed within the corresponding display areas. The method may also include receiving a first input via a waveform selection control displayed in a waveform selection area, and adjusting the display of at least one of the first waveform or the second waveform within the waveform display area to display in accordance with the first input.

Another embodiment of an apparatus may include processing circuitry configured to perform another set of actions. The processing circuitry may be configured to concurrently display a first waveform display area and a second waveform display area. The first waveform display area may display a first waveform. The first waveform display area may include a first plurality of display areas corresponding to sensor readings associated with the first waveform. The second waveform display area may display a second waveform. The second waveform display area may include a second plurality of display areas corresponding to sensor readings associated with the second waveform. The apparatus may also be caused to receive a first input via a waveform selection control displayed in a waveform selection area. The first input may define at least a portion of the first waveform. The apparatus may also adjust the display of the first waveform within the first waveform display area to display the portion of the first waveform defined by the first input.

Another example embodiment of a computer program product may include a non-transitory computer-readable storage medium bearing computer program instructions embodied therein for use with a computer. The computer program instructions may include program instructions configured to concurrently display a first waveform and a second waveform within a waveform display area. The waveform display area may include a plurality of display areas corresponding to sensor readings. Sensor readings associated with each waveform may be concurrently displayed within the corresponding display areas. The program instructions may also include program instructions configured to receive a first input via a waveform selection control displayed in a waveform selection area and program instructions configured to adjust the display of at least one of the first waveform or the second waveform within the waveform display area to display in accordance with the first input.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a functional diagram depicting an example apparatus in communication with a medical diagnostic device in accordance with example embodiments of the present invention;

FIG. 3 is an illustration of an example user interface display for displaying waveforms in accordance with example embodiments of the present invention;

FIG. 4 is a flow diagram of an example method for displaying waveforms in accordance with example embodiments of the present invention;

FIG. 5 is a flow diagram of an example method for selecting a portion of two or more waveforms for display in accordance with example embodiments of the present invention;

FIG. 6 is an illustration of an example user interface for displaying waveforms using a lock interface control in accordance with embodiments of the present invention;

FIG. 7 is a flow diagram of an example method for using a lock interface control to display waveforms in accordance with embodiments of the present invention;

FIG. 8 is an illustration of an example user interface for displaying a plurality of waveforms in accordance with embodiments of the present invention; and

FIG. 9 is a flow diagram of an example method for displaying a plurality of waveforms in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Introduction and Definitions

A method, apparatus and computer program product are provided in accordance with an example embodiment of the present invention in order to display waveforms. In this regard, a method, apparatus and computer program product of an example embodiment may receive waveform data. The waveform data may include two or more waveforms. These waveforms may correspond to readings taken for a particular patient using a waveform recording device, such as an electrocardiograph or an electroencephalograph. Embodiments may format this waveform data in a manner that facilitates comparison of two separate waveforms, such as a first waveform from a previous measurement (e.g., a “known good” measurement) in the patient's medical history, and a second waveform captured at a later time. Comparison between the waveforms may be provided on a display screen, such as a display coupled to a smartphone or tablet computer. Embodiments may provide various ways of formatting and displaying these waveforms to facilitate comparison and leverage the use of a particular display and input devices. For example, embodiments may leverage features of touch screen input devices to improve the ability of practitioners to align waveforms.

For the purposes of this application, the term “waveform information” should be understood to refer to information provided by medical diagnostic devices, including but not necessarily limited to electrocardiogram waveforms or electroencephalograph waveforms. Said waveform information may also include metadata describing the waveform (e.g., measurements from a series of leads affixed to a patient), the diagnostic device used to capture the waveform, the time, date, or facility in which the waveform was captured, the patient associated with the waveform, or the like. A given waveform may include measurements from a plurality of sensors. For example, a waveform may include measurements from multiple leads of an electrocardiograph (e.g., information received from Lead I, Lead II, Lead II, Lead aVR, Lead aVL, Lead aVF, and Leads V1-V6 of a 12 lead electrocardiogram). As such, the term “waveform” should be understood to refer to a particular set of readings from an example device, such that a single waveform may encompass multiple sensor readings. The waveform information may include a plurality of waveforms. For example, a given set of waveform information may include data describing all waveforms captured for a particular patient over the patient's medical history. Alternatively, waveform information may include a single waveform captured during a single diagnostic operation.

For the purposes of this application, the term “medical diagnostic device” should be understood to refer to a device or combination of devices that is equipped and/or configured to capture and/or display patient diagnostic data, such as waveform information. For example, a medical diagnostic device may include a monitor (e.g., a resting electrocardiograph device) that measures and stores patient waveform information for later analysis. In other embodiments, a medical diagnostic device may include a specially configured computer for analyzing waveform information. For example, a medical diagnostic device may include a smartphone, laptop, or tablet computer programmed for display and analysis of waveform information. As yet another example, a medical diagnostic device may include both a sensor device (e.g., a device for measuring waveform information and transmitting the information) and an analysis device (e.g., a computer for analyzing and displaying waveform information received from the sensor device).

### Example Apparatus

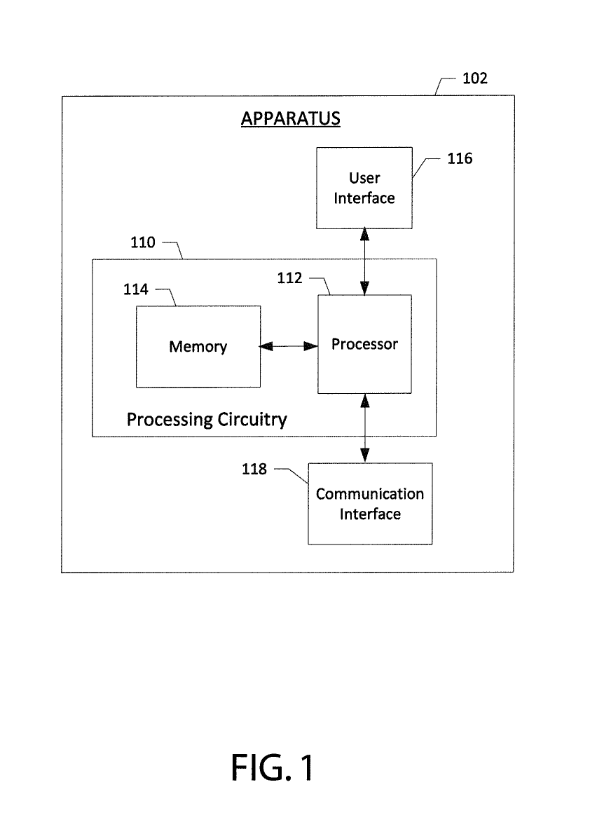

FIG. 1 illustrates a block diagram of an apparatus 102 in accordance with some example embodiments. The apparatus 102 may be any computing device capable of facilitating viewing and analysis of waveform information as described herein. For example, the apparatus 102 may be implemented on a smart phone, personal digital assistant, tablet computer, netbook computer, laptop, or desktop. The apparatus 102 may be operable to display waveform information to a user, and to facilitate the comparison of multiple waveforms. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, an electronic sensor for capturing human body movements, and/or other input/output mechanisms. In some embodiments, the user interface 116 includes a touch screen input device for displaying waveform information. The touch screen input device may facilitate formatting and output of waveform information to assist a practitioner with comparison and analysis of multiple waveforms. Although described with respect to a touch screen, it should also be appreciated that the user interface 116 may be provided via other techniques, such as a display device in concert with a mouse, keyboard, joystick, touchpad, or the like.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods. In some embodiments, the communication interface 118 may be configured to communicate with an external device, such as a sensor device capturing waveform information as described above. Additionally or alternatively, the communication interface 118 may communicate with a remote datastore (e.g., a medical records database) to obtain stored waveform information.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example Device Architecture

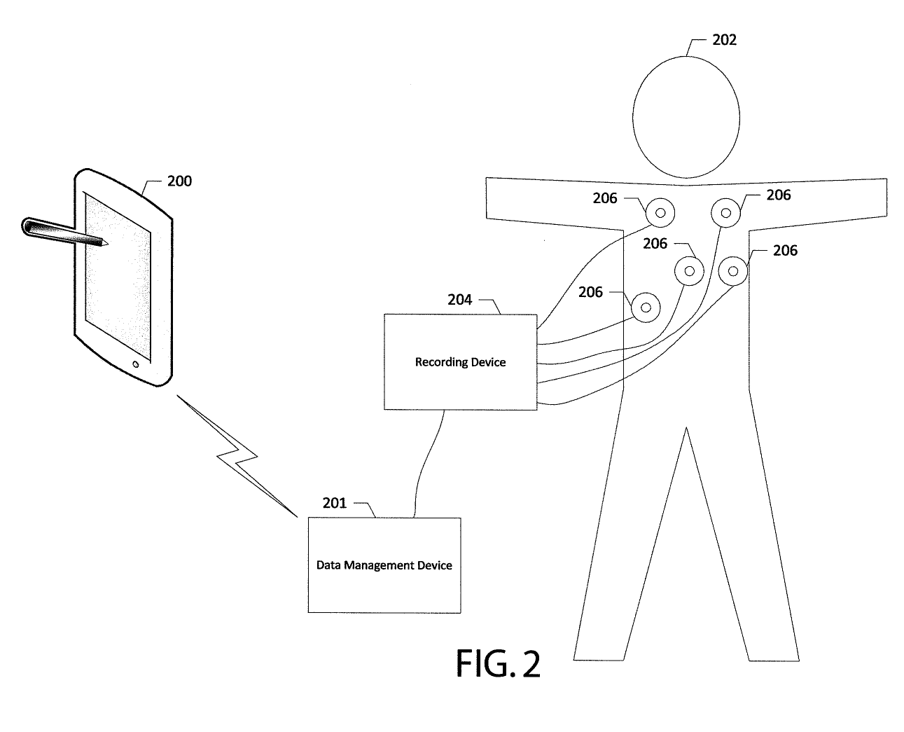

FIG. 2 is a block diagram of a device architecture in accordance with example embodiments of the present invention. The illustration depicts a recording device 204 coupled to a patient 202 in communication with a display device 200 via a data management device 201. The display device 200 may be a computing device as known in the art, such as a smartphone, a laptop, a tablet computer, or the like. For example, the display device 200 may be an apparatus 102 as described above with respect to FIG. 1. The recording device 204 may be any device capable of capturing, monitoring, or generating waveform information as described above, such as an electrocardiograph or electroencephalograph. The recording device 204 is coupled to the patient 202 via a series of monitoring leads 206. The monitoring leads 206 may each measure current at particular locations on the patient body. These changes in current may be stored as a particular waveform or as part of a set of waveform information. The recording device 204 may capture the waveform or set of waveform information. For example, the recording device 204 may include a storage medium to store the waveform or set of waveform information in non-volatile storage for later review and analysis. This stored information may later be accessed by a data management device 201 for viewing and analysis. Additionally or alternatively, the recording device 204 may communicate the waveform or set of waveform information to the data management device 201 during monitoring (e.g., in real-time). For example, the recording device 204 may communicate with the display device 200 via Bluetooth®, Wi-Fi, or the like. The data management device 201 may store and provide data to the display device 200 in a format suitable for output via the display device 202. For example, the display device 200 may include one or more interfaces for interacting with and/or configuring the data management device 201 (e.g., beginning and ending monitoring operations). In some embodiments, the display device 200 may also include an interface for selecting particular waveforms for display, such as an interface for interacting with stored patient medical records, an interface for connecting to a particular recording device 204, and the like. Although the instant example is provided with respect to separate structures for a display device 200, a data management device 201, and a recording device 204, it should be appreciated that various functions could be combined into a single device, such as a display device 200 that also performs the functionality of a data management device 201, a recording device 204 that also interfaces with a display device as a data management device 201, a single device that monitors leads, stores waveform data, and displays the waveform data, or any other combination of devices.

### First Example Interface

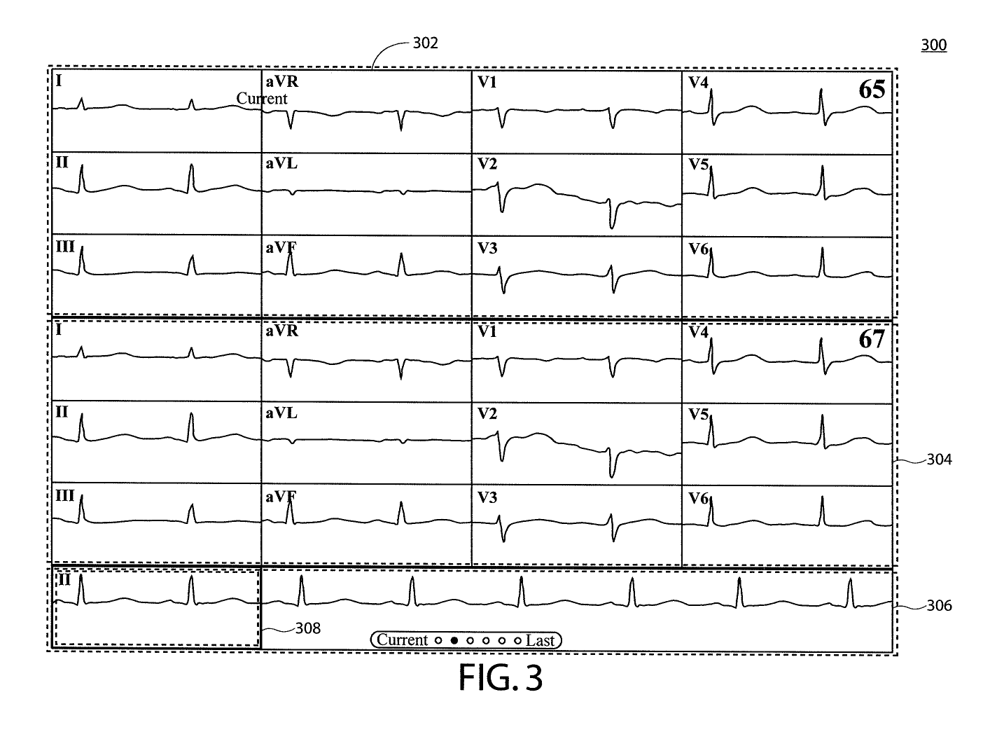

FIG. 3 depicts a first example interface 300 for comparing two waveforms relating to captured electrocardiograph data. The interface 300 includes a first waveform display area 302, a second waveform display area 304, and a waveform selection area 306. The first waveform display area 302 displays information for a first waveform, separated into 12 display windows corresponding to the 12 sensor leads of an example 12 lead electrocardiograph. Although the instant examples are described with respect to a 12 lead display, it should be readily appreciated that such a display might be formatted for different numbers of leads, such as a single lead display, a 6 lead display, an 18 lead display, or the like, depending upon the configuration of the waveform recording device. The second waveform display area 304 displays information for a second waveform, likewise separated into 12 separate display windows corresponding to sensor leads. In the present example, the first waveform display area 302 is disposed above the second waveform display area 304, resulting in a vertical stack of the two waveform display areas.

The particular portions of the first waveform and the second waveform may be controlled using the waveform selection area 306. The waveform selection area 306 may include a waveform selection control 308. The waveform selection control 308 may be used by a practitioner to determine which portions of the first waveform and the second waveform are presented in the windows of the first waveform display area 302 and the second waveform display area 304. For example, the user may drag a sliding box or window to determine the area of the waveform displayed in each of the displayed areas. The waveform selection area 306 may display an entire selectable portion of a waveform for analysis.

In the present example interface 300, the “II” lead of the first waveform is displayed. However, the waveform selection area 306 may display any particular lead or leads of the first waveform, the second waveform, or both. For example, the waveform selection area 306 may display the “II” lead of both waveforms, either superimposed upon one another or with a vertical separation, or the waveform selection area 306 may display both the “I” and “II” leads of the first waveform vertically separated. In some embodiments, the user may select a particular window of the first waveform display area 302 or the second waveform display area 304 corresponding to a particular lead, and, upon selection, the waveform selection area 306 may display the data associated with the particular selected window/lead.

The waveform selection area 306 may include a waveform selection control 308 used to determine how the waveform information is displayed in the first waveform display area 302 and the second waveform display area 304. The waveform selection control 308 may be manipulated via various input means, including but not limited to touch screen input, mouse cursor input, joystick input, keyboard input, or the like.

The waveform selection control 308 may be implemented as a sliding window or “box” that delineates the temporal boundaries of the portion of the waveform displayed in the windows of the first waveform display area 302 and the second waveform display area 304. The waveform displayed within the waveform selection area 306 may include the entire capture interval of the waveform data. For example, the waveform may have been captured for 10 seconds, 30 seconds, or a minute. However, the user viewing the waveform may wish to focus on particular intervals of the waveform, such as a part of the waveform corresponding to one or two heartbeats of an electrocardiogram. The waveform selection control 308 may allow the user to define the start and end portion of the portions of the waveform displayed in the corresponding display areas, such that the display areas are calibrated based on the start and end period defined by the waveform selection control 308.

The waveform selection control 308 may be fixed or dynamic. For example, a fixed waveform selection control may correspond to a particular interval (e.g., 1 second, 2 seconds, or 5 seconds) defined by the boundaries of the windows for each lead of the waveform display areas. Such a fixed waveform control 308 may be moved to define which particular interval is displayed. Alternatively, if the waveform selection control is dynamic, the user may define a start and end portion of the waveform, such as by selecting the right edge of the waveform selection control to specify an end portion of the waveform, and selecting the left edge of the waveform selection control to specify a start portion of the waveform, and adjusting the width and/or aspect ratios of the windows of the correspond display areas to account for the length of the portion of the waveform defined by the waveform selection control. In this manner, the user may dynamically adjust the duration of the waveform displayed in the display areas.

In order to provide for efficient comparison of the two waveforms, it may be advantageous to ensure that the first waveform display area 302 and the second waveform display area 304 are synchronized with one another. For example, if the user wishes to compare information for a single “beat” of two electrocardiograms, then the user may prefer to have the single beat lined up in the center of each window of the first waveform display area 302 and the second waveform display area 304. However, data capturing operations may begin at different times relative to patient cardiac waveforms. For example, a first waveform may begin capturing at the middle of a patient heartbeat, while a second waveform may be capturing just after a patient heartbeat. For example, the waveforms may be aligned by aligning the “QRS” interval of a waveform with another section of the waveform. As such, aligning a first waveform via the waveform selection area 306 to display a particular beat may not align the second waveform in the same manner if the waveform selection control 308 is used to define the displayed portion of both the first waveform and the second waveform from an arbitrary beginning. As such, the interface 300 may include methods and procedures for ensuring efficient comparison of both waveforms.

In a first example, the display may attempt to programmatically align the first waveform and the second waveform for selection. For example, an algorithm may examine the first waveform and the second waveform for commonalities in each waveform (e.g., certain peaks in amplitude of the waveform for particular leads) to determine where to establish a “beginning beat” of each waveform for the purposes of display. For example, a first waveform may contain a first “peak” of a “III” lead at 1.5 seconds into the waveform recording, while a second waveform might contain a first peak of the “III” lead at 1.3 seconds into the waveform recording. In such a case, the initial recording time of the first waveform might be advanced to 0.2 seconds into the recording, to cause the peaks of the III lead to occur at the same time. Adjusting the waveform selection control 308 in such an instance might select portions of the first waveform corresponding to the selected time, while the selected portions of the second waveform might correspond to the selected time minus 0.2 seconds. In some embodiments, the user does not need to first determine which portion of the waveform is being examined prior to the waveform being programmatically adjusted. For example, programmatic adjustment of a first waveform or a second waveform may occur upon opening of the second waveform. In response to opening the second waveform, one or both of the waveforms may be adjusted to align the first peaks of both waveforms (e.g., the “QRS” intervals of the first heartbeats).

Alternatively or additionally, the interface 300 may allow for manual calibration of waveforms. For example, each waveform may be associated with a different waveform selection area 306 or waveform selection control 308. Selection of the first waveform area 302 or the second waveform area 304 may alter the waveform displayed in the waveform selection area 306. For example, if a “lead” window within the first waveform display area is selected (e.g., by a tap on a touch screen), then the waveform displayed in the waveform selection area 306 may be the data from the selected lead of the first waveform, and if a lead window of the second waveform display area is selected, then the waveform displayed in the waveform selection area 306 may be the data from the selected lead of the second waveform. Each selected waveform may display a different waveform selection control 308, such that the portions of the waveform displayed in the respective waveform display area are modified based on the corresponding waveform selection control. As such, a user wishing to compare two waveforms might first select the first waveform, adjust the waveform selection control for the first waveform, then select the second waveform, and adjust the waveform selection control for the second waveform, until both waveforms are in a suitable position for comparison within their respective waveform display areas. In some embodiments, different user input operations are associated with selection and manipulation of particular waveforms. For example, a user may use a single finger drag operation to manipulate a first waveform, and a two finger drag operation to manipulate a second waveform. As another example, a left mouse click and drag may be used to manipulate a first waveform, and a right mouse click and drag may be used to manipulate a second waveform.

In yet further embodiments, the interface 300 may be employed for comparison of more than two waveforms. For example, the user may be presented with a selection of multiple waveforms via a menu or scroll bar. As each waveform is selected via the menu or scroll bar, the waveform may be displayed within the waveform selection area 306. The user may display a particular waveform within the first waveform display area or the second waveform display area by selecting the waveform from the menu, scroll bar, or within the waveform selection are 306. For example, the user may drag a waveform displayed in the waveform selection area 306 to the first waveform display area 302 or the second waveform display area 304 to populate the first waveform display area 302 or the second waveform display area 304 with the selected waveform. Additionally or alternatively, it should be appreciated that more than two waveforms could be displayed in this manner, such as by including a third or more waveform display areas adjacent to the first waveform display area or the second waveform display area.

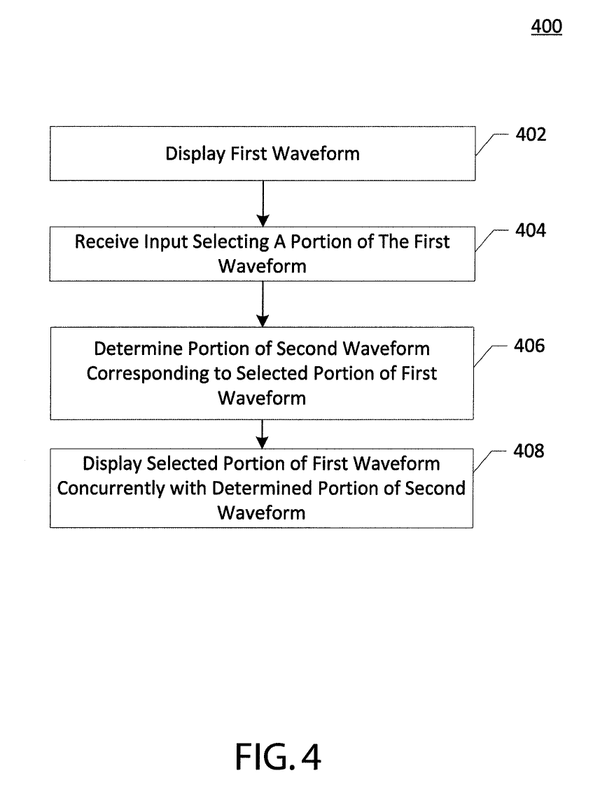

FIG. 4 is a flow diagram of an example method 400 for displaying waveforms in accordance with example embodiments of the present invention. For example, the method 400 may be employed to display waveforms via an interface as described above with respect to FIG. 3. The method 400 may correspond to embodiments that programmatically or otherwise automatically determine a portion of a second waveform to be displayed based on a selected portion of a first waveform, such as by analysis of the two waveforms for similarities. Embodiments of the method 400 may be employed by an apparatus, such as the apparatus 102 described with respect to FIG. 1, the display device 200 described with respect to FIG. 2, and/or processing means, such as the processor 102.

At action 402, a first waveform is displayed. Display of the first waveform may include displaying data from a plurality of sensor leads as described above with respect to FIG. 3. At action 404, an input may be received for selecting a portion of the first waveform. For example, the user may provide input via a waveform selection control as described above with respect to FIG. 3, in order to define a particular portion of the first waveform for display.

At action 406, a portion of the second waveform corresponding to the selected portion of the first waveform may be determined. For example, the first waveform and the second waveform may be programmatically calculated as described above, and selection of a particular time interval of the first waveform may be adjusted based on the calibration to define a portion of the second waveform corresponding to the same “beat” of sensor input. At action 408, the selected portion of the first waveform may be displayed concurrently with the determined portion of the second waveform to facilitate comparison between the two waveforms.

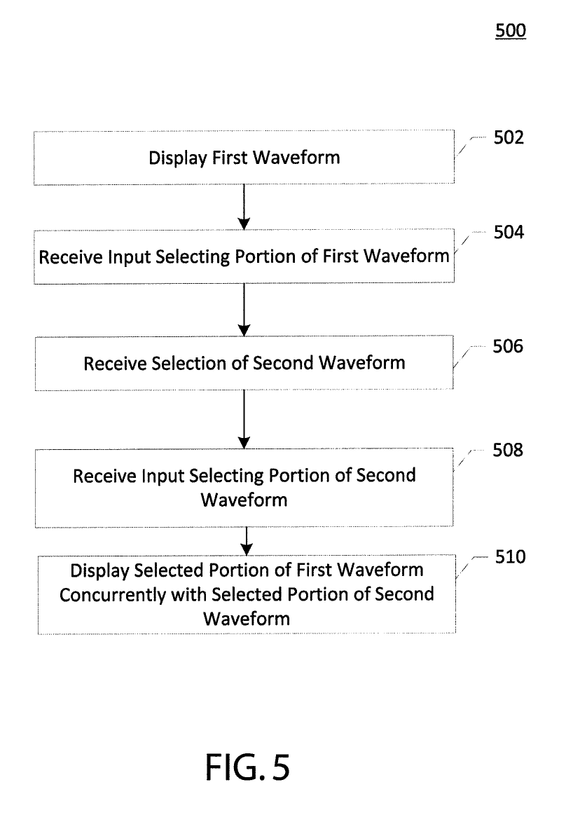

FIG. 5 is a flow diagram of an example method 500 for selecting portions of a plurality of waveforms in accordance with example embodiments of the present invention. For example, the method 500 may be employed to display waveforms via an interface as described above with respect to FIG. 3. The method 500 may correspond to embodiments in which a user selects a portion of a first waveform and a portion of a second waveform manually, such as by using a waveform selection control as described above with respect to FIG. 3. Embodiments of the method 500 may be employed by an apparatus, such as the apparatus 102 described with respect to FIG. 1, the display device 200 described with respect to FIG. 2, and/or processing means, such as the processor 102.

The method 500 may begin with display of a first waveform at action 502. Display of the first waveform may correspond with displaying sensor data associated with the first waveform (e.g., input data from a particular lead) in a waveform selection area as described above with respect to FIG. 3. At action 504, an input is received (e.g., user manipulation of a waveform selection control as described with respect to FIG. 3), selecting a particular portion of the first waveform. Input provided in this manner may alter the display of the waveform within a display area corresponding to a first waveform, such as the first waveform display area described above.

At action 506, a selection of a second waveform is received. For example, user input may select a waveform displayed in a second waveform display area (e.g., by tapping the second waveform display area on a touch screen) or select a file corresponding with a second waveform from a selection menu. Selection of the second waveform may also include population of a waveform selection area with the selected second waveform, replacing or in addition to a first waveform displayed in the waveform selection area.

At action 508, input is received selecting a portion of the second waveform. As with the input related to the first waveform, this input may use a waveform selection control to define a portion of the waveform for display in the corresponding waveform display area. At action 510, the selected portions of each waveform may be displayed in the respective waveform display areas. It should be appreciated that display of each waveform may be performed simultaneously with respect to the input operations. For example, as a user adjusts a waveform selection control, the corresponding waveform display areas may be dynamically updated during the input operation. In this manner, the user may adjust each waveform to facilitate comparison between the two waveforms. For example, a user may adjust each waveform so that a particular “beat” is located within the center of a particular lead window, in order to compare the two waveforms during a medical diagnostic operation.

### Second Example Interface

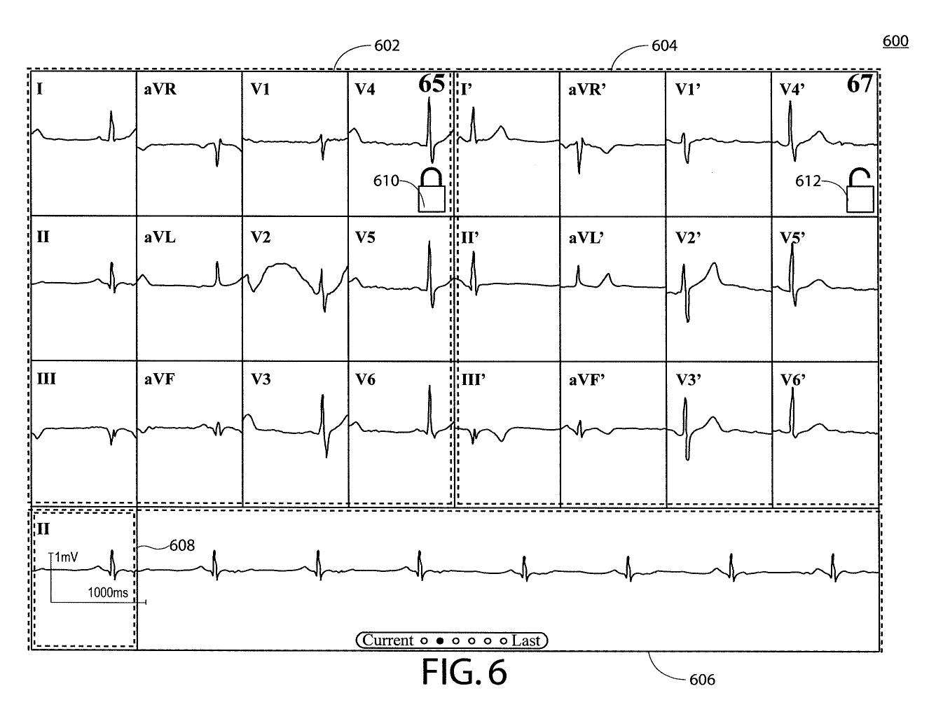

FIG. 6 depicts a second example interface 600 for comparing two waveforms relating to captured electrocardiograph data. The interface 600 includes a first waveform display area 602, a second waveform display area 604, and a waveform selection area 606. As with the first interface 300 described above, the first waveform display area 602 displays information for a first waveform, separated into 12 display windows corresponding to the 12 sensor leads of an example 12 lead electrocardiograph. As described above, various other display configurations may be implemented for electrocardiographs with different numbers of leads (e.g., a single window for a single lead electrocardiograph, 18 leads for an 18 lead electrocardiograph, or the like). The second waveform display area 604 similarly displays information for a second waveform, likewise separated into separate display windows corresponding to sensor leads. In the second example interface 600, the waveform display areas are disposed side-by-side, in a horizontal fashion.

The second interface depicts a first lock control 610 associated with the first display area 602 and a second control icon 612 associated with the second display area 604. The lock controls 610, 612 may be employed to determine whether the corresponding display area updates in response to input provided via a waveform selection area 306 and a corresponding waveform selection control 608. In the present example, the waveform selection control 608 may be employed to adjust whichever of the waveform display areas is not “locked”. A user may choose to lock or unlock a given display area via manipulation of the corresponding lock control (e.g., by tapping the lock control in a touch screen, by selecting the lock control with a mouse cursor, by entering a hotkey combination on a keyboard associated with the lock, or the like). If a particular waveform display area is locked, then altering the selected portion of a waveform displayed within the waveform selection area will not alter the display within the locked waveform display area. As described above with respect to FIG. 3, different user input operations may be associated with selection and manipulation of particular waveforms. For example, a user may use a single finger drag operation to manipulate both waveforms, and a two finger drag operation to manipulate a second waveform. In this manner, the user may employ a single finger drag and a two finger drag to align the two waveforms and to scroll to review different portions of both waveforms. In some embodiments, use of different input methods as described may reduce or eliminate the need for a “lock” control. As another example, a left mouse click and drag may be used to manipulate a first waveform, and a right mouse click and drag may be used to manipulate a second waveform.

In some embodiments (e.g., where each waveform has a separate waveform selection control, as described above), an interface object associated with the waveform selection control will appear to be immovable if the waveform associated with the control is locked. If the user attempts to move the waveform selection control when the waveform is locked, the user may be provided with audio, visual, or tactile feedback to indicate the operation is not allowed in a locked state. In some embodiments, locking a particular waveform display area may remove display of the corresponding waveform from the waveform selection area, such that all unlocked waveforms are displayed within the waveform selection area, and as waveforms are locked, they are removed.

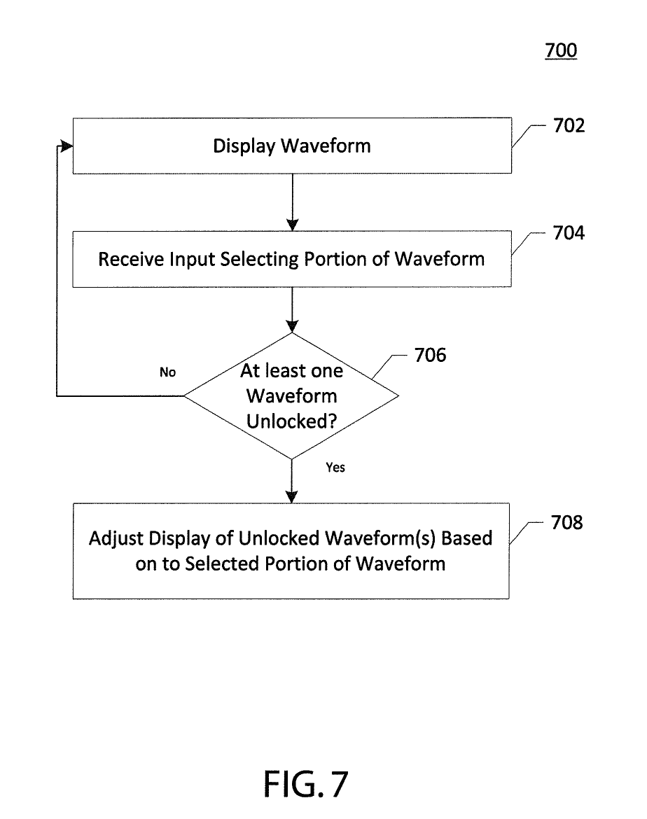

FIG. 7 is a flow diagram of an example method 700 for displaying waveforms in accordance with example embodiments of the present invention. For example, the method 700 may be employed to utilize “lock” controls to control the display of waveforms via an interface as described above with respect to FIG. 6. Embodiments of the method 700 may be employed by an apparatus, such as the apparatus 102 described with respect to FIG. 1, the display device 200 described with respect to FIG. 2, and/or processing means, such as the processor 102.

At action 702, one or more waveforms are displayed as described above with respect to FIG. 1-6. At action 704, input is received for selecting a particular portion of the displayed waveform or waveforms. At action 706 a determination is made as to whether the one or more of the waveforms are unlocked. For example, a waveform may be identified as unlocked if a “lock” control associated with the waveform has not been activated via user input. Alternatively, in some embodiments a lock control may be enabled by default. As yet another alternative, whether a waveform is locked or not may be a saved state associated with the waveform, such that the locked status of the waveform corresponds to the locked status when the waveform was most recently saved or analyzed. If at least one waveform is not unlocked, no activity is performed since none of the waveforms will have their attendant displays altered. As such, the method proceeds to action 702 if no waveforms are unlocked.

If at least one waveform is unlocked, the method may update the unlocked waveforms at action 708. The unlocked waveforms may be updated based on the portion of the waveform selected by the input received at action 704. For example, two unlocked waveforms may be updated based on a calibrated display as described with respect to FIGS. 3 and 4, or only waveforms associated with the particular waveform selection control that received the input may be updated as described with respect to FIGS. 3 and 5.

### Third Example Interface

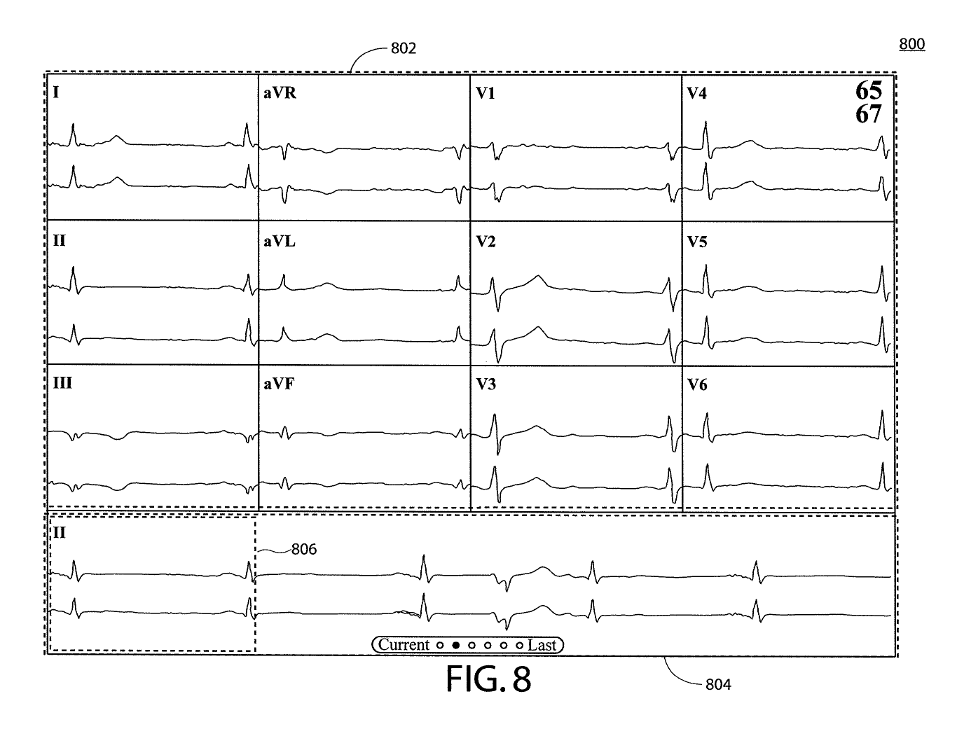

FIG. 8 depicts a third example interface 800 for comparing two waveforms relating to captured electrocardiograph data. The interface 800 includes a waveform display area 802 and a waveform selection area 804. As with the first interface 300 and the second interface 600 described above, the waveform display area 804 displays information for a waveform. However, unlike the first interface 300 and the second interface 600, the waveform display area 802 is configured to display two waveforms simultaneously in the same display area. As depicted in FIG. 8, the waveform display area 800 displays waveform information for two separate waveforms vertically offset from one another. In this manner, the windows corresponding to each lead of the waveform display the corresponding lead information from both waveforms.

The particular portion of each waveform that is displayed may be controlled by the waveform selection area 804 in a similar manner as described above with respect to the interfaces 300 and 600. A waveform selection control 806 may be employed to adjust the displayed portion of each waveform. As described above with respect to FIGS. 3 and 6, different user input operations may be associated with selection and manipulation of particular waveforms. For example, a user may use a single finger drag operation to manipulate a first waveform, and a two finger drag operation to manipulate a second waveform. As another example, a left mouse click and drag may be used to manipulate a first waveform, and a right mouse click and drag may be used to manipulate a second waveform. As described above, adjustment of the waveform selection control may define a portion of the waveforms displayed in the lead windows. Input operations associated with one waveform or the other (e.g., the single finger vs. two finger input or left mouse drag vs. right mouse drag operations described above) may scroll the associated waveform within the windows without moving the waveform selection control or the unselected waveform. In some embodiments, the user may be able to adjust the vertical displacement between the first waveform and the second waveform according to various inputs. For example, a mouse scroll wheel scrolling up may increase the vertical displacement while a mouse scroll wheel scrolling down may decrease the vertical displacement. By placing the waveforms in the same window and aligning the waveforms with one another, users may easily compare the waveforms in both amplitude and duration, reducing or eliminating the need for additional measurement interface controls.

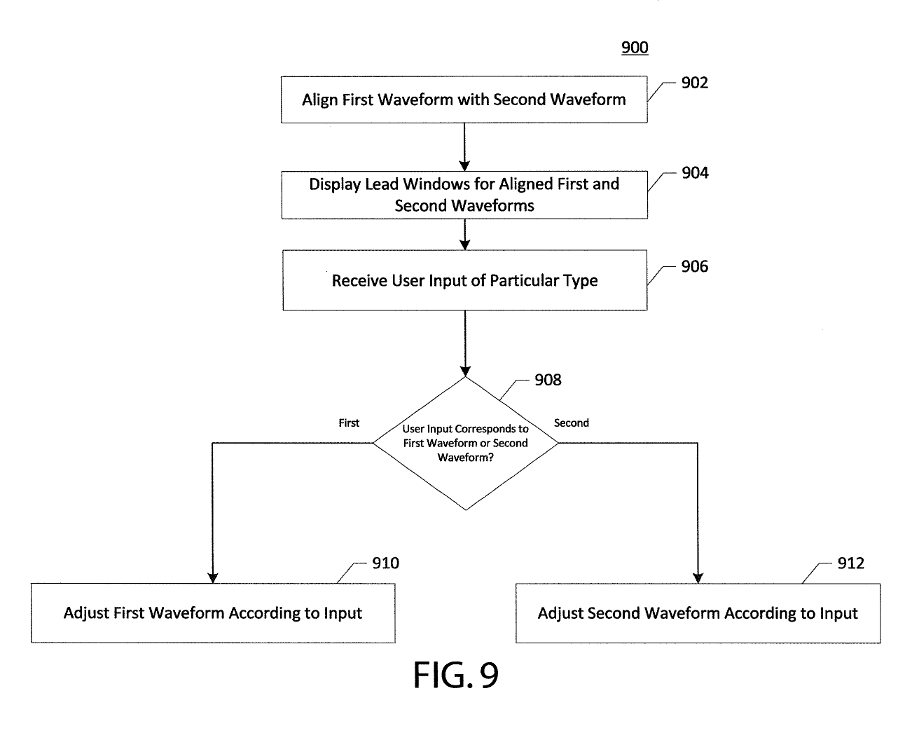

FIG. 9 is a flow diagram of an example method 900 for displaying waveforms in accordance with example embodiments of the present invention. For example, the method 900 may be employed to discriminate between user inputs for two different waveforms to allow for efficient adjustment of a plurality of waveforms in a display as described above with respect to FIG. 8. Embodiments of the method 800 may be employed by an apparatus, such as the apparatus 102 described with respect to FIG. 1, the display device 200 described with respect to FIG. 2, and/or processing means, such as the processor 102.

At action 902, a first waveform is aligned with a second waveform. The waveforms may be aligned according to various methods as described with respect to FIGS. 1-8. For example, the waveforms may be manually aligned by a user or programmatically aligned by an algorithm. At action 904, a set of lead windows are displayed. The lead windows may display the waveforms simultaneously in the same windows (e.g., as described with respect to FIG. 8), or there may be a separate set of lead windows for each waveform (e.g., as described with respect to FIGS. 3 and 6). At action 906, a user input of a particular type is received, corresponding to one or more of the waveforms. For example, the user input may be a left mouse click, a right mouse click, a single finger drag, a dual finger drag, or the like. At action 908, the method 900 differentiates between whether the input is associated with the first waveform, the second waveform, or both waveforms. If the input corresponds to the first waveform, the first waveform is adjusted at action 910. If the input corresponds to the second waveform, the second waveform is adjusted at action 912. It should also be appreciated that some embodiments may include a universal input that adjusts all displayed waveforms (e.g., use of three fingers in a drag operation, or clicking and holding a third mouse button or scroll wheel).

It will be understood that each element of the flowchart, and combinations of elements in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
concurrently displaying a first waveform display area and a second waveform display area, wherein the first waveform display area displays a first waveform, wherein the first waveform display area comprises a first plurality of display areas corresponding to sensor readings associated with the first waveform, wherein the second waveform display area displays a second waveform, and wherein the second waveform display area comprises a second plurality of display areas corresponding to sensor readings associated with the second waveform;
receiving a first input via a waveform selection control displayed in a waveform selection area, the first input defining at least a portion of the first waveform; and
adjusting the display, using a processor, of the first waveform within the first waveform display area to display the portion of the first waveform defined by the first input.

2. The method of claim 1, further comprising:
receiving a second input via the waveform selection control defining at least a portion of the second waveform; and
adjusting the display of the second waveform within the second waveform display area to display the portion of the second waveform defined by the second input.

3. The method of claim 1, further comprising:
determining a portion of the second waveform associated with the first input; and
adjusting the display of the second waveform in accordance with the determined portion of the second waveform.

4. The method of claim 3, wherein the portion of the second waveform is determined by calibrating at least one first measured amplitude of the second waveform with at least one first measured amplitude of the first waveform.

5. The method of claim 1, further comprising:
receiving a third input via at least one of the first plurality of display areas, the third input indicating a selection of a particular display area of the first plurality of display areas; and
displaying a waveform corresponding to a sensor reading associated with the selected particular display area in the waveform selection area.

6. The method of claim 1, further comprising:
determining that a lock control associated with the first waveform is not engaged for the first waveform; and
adjusting the first waveform only in response to determining the lock control is not engaged.

7. The method of claim 1, wherein the waveform selection control is associated with the first waveform, and wherein the method further comprises:
receiving a selection input to select the second waveform; and
in response to receiving the selection input to select the second waveform, displaying a waveform selection control corresponding to the second waveform in the waveform selection area.

8. The method of claim 1, wherein the first waveform and the second waveform are electrocardiogram waveforms.

9. The method of claim 8, wherein each of the first plurality of display areas and the second plurality of display areas are associated with a particular lead of the electrocardiogram waveforms.

10. An apparatus comprising processing circuitry configured to cause the apparatus to:
concurrently display a first waveform display area and a second waveform display area, wherein the first waveform display area displays a first waveform, wherein the first waveform display area comprises a first plurality of display areas corresponding to sensor readings associated with the first waveform, wherein the second waveform display area displays a second waveform, and wherein the second waveform display area comprises a second plurality of display areas corresponding to sensor readings associated with the second waveform;
receive a first input via a waveform selection control displayed in a waveform selection area, the first input defining at least a portion of the first waveform; and
adjust the display of the first waveform within the first waveform display area to display the portion of the first waveform defined by the first input.

11. The apparatus of claim 10, further caused to:
receive a second input via the waveform selection control defining at least a portion of the second waveform; and
adjust the display of the second waveform within the second waveform display area to display the portion of the second waveform defined by the second input.

12. The apparatus of claim 10, further caused to:
determine a portion of the second waveform associated with the first input; and
adjust the display of the second waveform in accordance with the determined portion of the second waveform.

13. The apparatus of claim 12, wherein the portion of the second waveform is determined by calibrating at least one first measured amplitude of the second waveform with at least one first measured amplitude of the first waveform.

14. The apparatus of claim 10, further caused to:
receive a third input via at least one of the first plurality of display areas, the third input indicating a selection of a particular display area of the first plurality of display areas; and
display a waveform corresponding to a sensor reading associated with the selected particular display area in the waveform selection area.

15. The apparatus of claim 10, further caused to:
determining that a lock control associated with the first waveform is not engaged for the first waveform; and
adjusting the first waveform only in response to determining the lock control is not engaged.

16. The apparatus of claim 10, wherein the waveform selection control is associated with the first waveform, and wherein the apparatus is further caused to:
receive a selection input to select the second waveform; and
in response to receiving the selection input to select the second waveform, display a waveform selection control corresponding to the second waveform in the waveform selection area.

17. The apparatus of claim 10, wherein the first waveform and the second waveform are electrocardiogram waveforms.

18. The apparatus of claim 17, wherein each of the first plurality of display areas and the second plurality of display areas are associated with a particular lead of the electrocardiogram waveforms.

19. A computer program product comprising at least one non-transitory computer-readable storage medium bearing computer program instructions embodied therein for use with a computer, the computer program instructions comprising program instructions configured to:
concurrently display a first waveform display area and a second waveform display area, wherein the first waveform display area displays a first waveform, wherein the first waveform display area comprises a first plurality of display areas corresponding to sensor readings associated with the first waveform, wherein the second waveform display area displays a second waveform, and wherein the second waveform display area comprises a second plurality of display areas corresponding to sensor readings associated with the second waveform;
receive a first input via a waveform selection control displayed in a waveform selection area, the first input defining at least a portion of the first waveform; and
adjust the display of the first waveform within the first waveform display area to display the portion of the first waveform defined by the first input.

20. The computer program product of claim 19, wherein the first waveform and the second waveform are electrocardiogram waveforms.
